(19) United States
(12) Patent Application Publication
(10) Pub. No.: US 2009/0164910 A1
(43) Pub. Date: Jun. 25, 2009

(54) Sharing of scheduling time-blocks

(75) Inventors: Katri T. Laakso, Tampere (FI); Petri M.O. Piippo, Lempaala (FI); Jan O. Blom, Espoo (FI); James F. Reilly, Helsinki (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/004,774

(22) Filed: Dec. 20, 2007

(51) Int. Cl. G06F 3/048; G06F 15/16

(52) U.S. Cl. 715/748

(57) ABSTRACT

An apparatus includes a data processor, a memory that stores an electronic calendar application and an associated electronic calendar database that stores data representing at least one electronic calendar, a user interface and a transmitter. The data processor is configurable to operate with the electronic calendar application and to receive user input from the user interface to generate a time-block from the at least one electronic calendar and to send the time-block through the transmitter to a recipient electronic calendar application in another apparatus. The user enters at least one date and a start time and an end time for the at least one date into the user interface for use in generating the time-block. The apparatus may further include a receiver configurable to receive a time-block from another electronic calendar application residing in another apparatus, where the data processor is further configurable to create a new electronic calendar that includes calendar entries received in the time-block. The apparatus may further include a receiver capable to optionally acknowledging receipt and actions performed on a time-block by the receiver to the originating sender.

### TECHNICAL FIELD

The exemplary and non-limiting embodiments of this invention relate generally to communication systems, methods, devices and computer programs and, more specifically, relate to techniques for operating a scheduling function, such as a calendar application of a mobile device.

### BACKGROUND

Events are a part of everyday life. Business meetings, birthday parties, plays and concerts are all examples of different events. Information descriptive of an event typically includes at least a date and time, a location and a subject. People add events to their calendars, and associate reminders with the added events, so as to ensure that they will be at the correct location at the correct time.

In many cases of interest more than one person attends a given event. As such, a need arises to share event information between different persons.

As one example, sharing information within a family concerning upcoming events can be important as family members need to know each other's schedules (e.g., irregular working hours) and need to agree about common events (e.g., visiting grandparents or picking up children from daycare).

Some electronic calendar applications enable sharing either a single calendar entry or an entire calendar. However, in many cases this degree of sharing is inadequate. In general, these approaches represent the extreme boundary conditions: i.e.; share nothing at all, share just a single calendar entry, or share an entire calendar.

For example, conventional electronic PC calendars, such as one provided by Google™ (http://www.google.com/calendar) and one provided by Mozilla™ (http://www.mozilla.org/projects/calendar/), allow users to share their calendar information, either events or entire calendars. In addition, a Calendar Core Application provided by the assignee of this patent application enables sending individual entries to other users via short message service (SMS), multimedia messaging service (MMS), Bluetooth™ or by email.

If a user wishes to share a block of several calendar entries (referred to in this document as a “time-block”), and not a single event and not a full calendar, the user has basically two options: create a new calendar containing only those entries that the user wishes to share at the moment, or send each calendar entry separately to others. Both of these approaches are far from optimal.

### SUMMARY OF THE EXEMPLARY EMBODIMENTS

The foregoing and other problems are overcome, and other advantages are realized, in accordance with the non-limiting and exemplary embodiments of this invention.

In accordance with a first aspect of the exemplary embodiments of this invention a method includes operating a user interface in conjunction with a source electronic calendar application to generate a time-block from at least one first electronic calendar; and sending the time-block to a recipient electronic calendar application.

In accordance with a further aspect of the exemplary embodiments of this invention a computer-readable memory medium stores program instructions the execution of which results in operations that comprise operating a user interface in conjunction with a source electronic calendar application to generate a time-block from at least one first electronic calendar; and sending the time-block to a recipient electronic calendar application.

In accordance with a further aspect of the exemplary embodiments of this invention there is provided an apparatus that includes a data processor, a memory that stores an electronic calendar application and an associated electronic calendar database that stores data representing at least one electronic calendar, a user interface and a transmitter. The data processor is configurable to operate with the electronic calendar application and to receive user input from the user interface to generate a time-block from the at least one electronic calendar and to send the time-block through the transmitter to a recipient electronic calendar application in another apparatus.

In accordance with another aspect of the exemplary embodiments of this invention there is provided an apparatus that includes means for interfacing to a communication network; means for presenting information to a user and for receiving information from the user; means for storing an electronic calendar application and at least one electronic calendar; and means responsive to information received from the user for generating a time-block from the at least one electronic calendar for sending the time-block to a recipient electronic calendar application through the interfacing means. The information received from the user comprises at least one date and a start time and an end time for the at least one date, and the time-block comprises a plurality of electronic calendar entries descriptive of a plurality of scheduled events that are defined by the at least one date and the start time and the end time for the at least one date. The apparatus may further comprise means responsive to a time-block received through the interfacing means for creating in the storing means a new electronic calendar containing entries that comprise those in received time-block, and may further include means for optionally acknowledging receipt of the time-block and for indicating an action taken by the user in response to receiving the time-block.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a block diagram of a device that is suitable for practicing the embodiments of this invention.

FIG. 2 is a block diagram of a network within which the device of FIG. 1 may be used.

FIGS. 3A-3I show exemplary display screen presentations during the use of the exemplary embodiments of this invention.

FIGS. 3J and 3K illustrate exemplary screen images that may appear on the display of a person receiving a shared time-block in accordance with the exemplary embodiments of this invention.

FIG. 4 is a logic flow diagram that illustrates a method, and the result of execution of computer program instructions by the data processor shown in FIG. 1.

### DETAILED DESCRIPTION

The exemplary embodiments of this invention enable the use of an advanced electronic calendar application to permit sharing calendar events with other users in the form of one or more time-blocks.

The exemplary embodiments of this invention are well suited for consumer and enterprise use cases and provide enhanced capabilities as compared to conventional approaches. For example, the exemplary embodiments of this invention permit a user to share a time range within a day, share an entire day, or share a time range spanning multiple days. The exemplary embodiments beneficially provide an ability for a user to share a “time-block”, where a time-block is defined as having a user-specified start time, end time, and date or dates. A time-block may contain from one to many individual calendar entries.

Other embodiments of time-blocks (i.e., time-block as a set of calendar entries with an earliest starting time and latest ending time) are also possible. As a non-limiting example, the user may select a contiguous time block (e.g., Tuesday morning from 7:00-12:00) but excluding a selected set of calendar entries (e.g., a Doctor appointment from 9:00 until 10:30), and representing an excluded entry or entries in the time-block instead as ‘empty’, or ‘busy’.

If the electronic calendar application 14B supports multiple calendars/categories, the user may select to exclude all entries from one of these, or show them only with free/busy indications. It this example the user may wish to share entries with a colleague and choose to share all details for work-related entries, but indicate only free/busy data for personal entries, and generate a related time-block for the certain time interval.

Thus, it can be appreciated that other embodiments of a time-block are useful and also possible to represent in accordance with the exemplary embodiments of this invention. For example, the use may select a basic time-block but exclude a specific entry (or entries), or the user may mark the specific entry or entries as ‘free/busy’, or show only the location of the entry, thereby preserving the user's privacy when creating a time-block for sharing entries from one or more electronic calendars.

Note that a ‘repeating time-block’ containing one or more repeating calendar entries may also be created and shared.

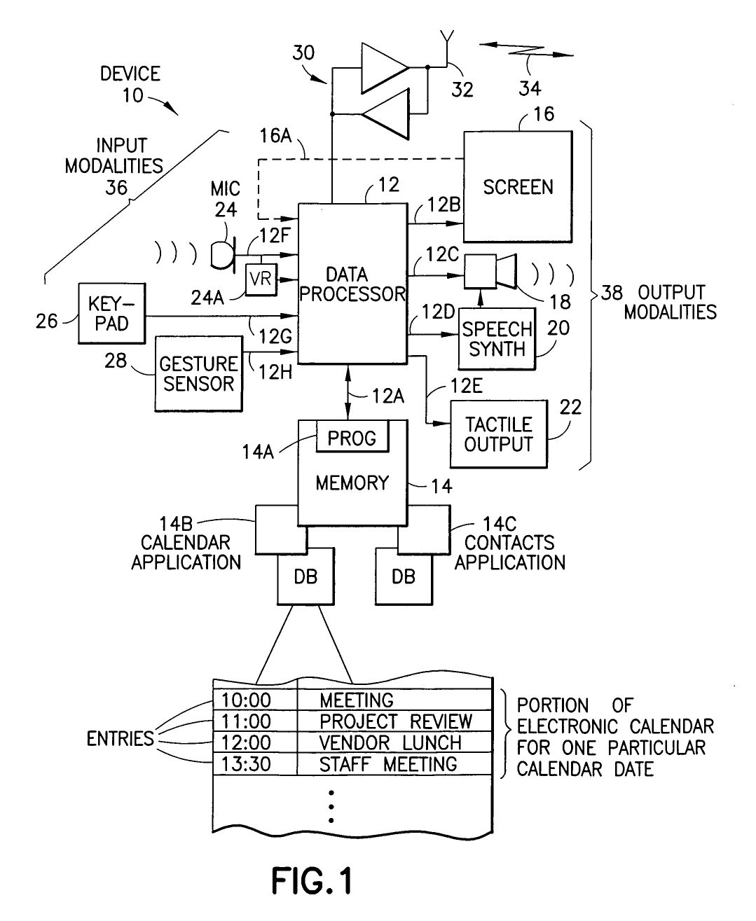

Reference is made to FIG. 1 for illustrating a simplified block diagram of an exemplary embodiment of an electronic device 10 that is suitable for use in practicing the exemplary embodiments of this invention. In FIG. 1 device 10 includes a data processor 12 that is coupled through a bus 12A with a memory 14 that stores a program (PROG) 14A of instructions that are executable by the data processor 12. The device 10 may further include a plurality of input and output devices and subsystems, referred to herein also as input modalities 36 and output modalities 38. As exemplary output devices there may one or more of a visual display screen 16, such as an LCD or a plasma display screen, an acoustic output transducer such as a loudspeaker 18, a speech synthesis subsystem 20 having an output that can be played through the loudspeaker 18 (or through another acoustic output transducer), and a tactile output device or transducer 22, such as a vibratory device (e.g., a piezoelectric transducer). These output devices are coupled to corresponding output paths 12B, 12C, 12D and 12E from the data processor 12. As exemplary input devices there may one or more of an acoustic input transducer such as a microphone 24, an associated speech or voice recognition function (VR) 24A, a keypad or keyboard 26 and a gesture sensor 28, such as a device that is responsive to a rotation about at least one axis and/or to a force applied by a user's finger or stylus, such as when making a tapping gesture. These input devices are coupled to corresponding input paths 12F, 12G and 12H to the data processor 12. If the screen 16 is a touch-sensitive screen then there may also be an input 16A from the screen 16 to the data processor 12. In this case the input to the data processor may represent activation of a virtual key or button by the user, as opposed to the use of the keypad/keyboard 26 where the input signal may represent activation of a physical key or button (such as an alphanumeric key or a physical ‘soft’ key or button). The microphone 24 may be coupled with the speech recognition functionality of the device 10 (the VR 24A) whereby a word or words spoken by the user can be interpreted by the data processor 12 as representing a command.

It should be appreciated that the data processor block 12 may actually comprise a number of circuit types, in addition to a data processor per se, such as analog-to-digital converters and digital-to-analog converters, that support the operation of the various input modalities 47 and output modalities 48.

In the exemplary embodiments the device 10 has user communication capabilities, and includes a suitable transceiver 30, such as a radio frequency transceiver coupled with at least one antenna 32 for conducting wireless communications through a bidirectional radio frequency link 34 (e.g., a link to a cellular communication network, or a low power radio frequency link such as a Bluetooth™ link). In other embodiments the transceiver 30 may be optically based and may then include suitable optical source and detector components, such as an infrared emitter and an infrared detector. In other embodiments the transceiver 30 may be adapted for non-wireless communication, such as communication through an optical or electrical conductor (e.g., a cable, a telephone line, or a in general wiring).

It should be noted that the various input modalities 36 and output modalities 38 are exemplary, and not all may be present in a given implementation. For example, the exemplary embodiments of this invention may be used with just the display screen 16 and the keypad/keyboard 26, or with just the display screen 16 if the screen is touch sensitive to permit the user to enter information and commands.

The PROG 14A is assumed to include program instructions that, when executed by the data processor 12, enable the electronic device 10 to operate in accordance with the exemplary embodiments of this invention, as will be discussed below in greater detail.

In general, the various embodiments of the device 10 can include, but are not limited to, cellular phones, personal digital assistants (PDAs) possibly having wireless communication capabilities, portable computers possibly having wireless communication capabilities, image capture devices such as digital cameras possibly having wireless communication capabilities, gaming devices possibly having wireless communication capabilities, music storage and playback appliances possibly having wireless communication capabilities, Internet appliances permitting wireless or wired Internet access and browsing, as well as portable units or terminals that incorporate combinations of such functions.

The exemplary embodiments of this invention may be implemented by computer software executable by the data processor 12, or by hardware, or by a combination of software and hardware (and firmware).

The memory 14 may be of any type suitable to the local technical environment and may be implemented using any suitable data storage technology, such as semiconductor-based memory devices, flash memory, magnetic memory devices and systems, optical memory devices and systems, fixed memory and removable memory. The data processor 12 may be of any type suitable to the local technical environment, and may include one or more of general purpose computers, special purpose computers, microprocessors, digital signal processors (DSPs) and processors based on a multi-core processor architecture, as non-limiting examples.

The memory 14 is shown as including computer program code that implements a calendar application (CA) 14B and associated database (DB), as well as a Contacts application 14C and associated database (DB). The Calendar application 14B is enhanced in accordance with the embodiments of this invention, as discussed below, to permit the selective sharing of specific calendar information with other devices.

Examples of electronic calendars can be found in commonly assigned U.S. Pat. No. 7,257,778, Kekki et al., “Calendar system and a method for producing a calendar view”, as well as in commonly assigned US Patent Application Publication 2007/0250366, Nurmi, “Apparatus, method and computer program product for annotating a meeting in an electronic calendar”.

FIG. 1 shows a portion of one electronic calendar for one particular calendar date, the portion having a plurality of entries. The plurality of electronic calendar entries are descriptive of a plurality of scheduled events (e.g., meetings, work tasks, meal times and so forth, as non-limiting examples). This particular calendar format is not to be considered limiting in any way, as the information represented in the database of the Calendar application 14B may be stored and presented in any manner that is desirable.

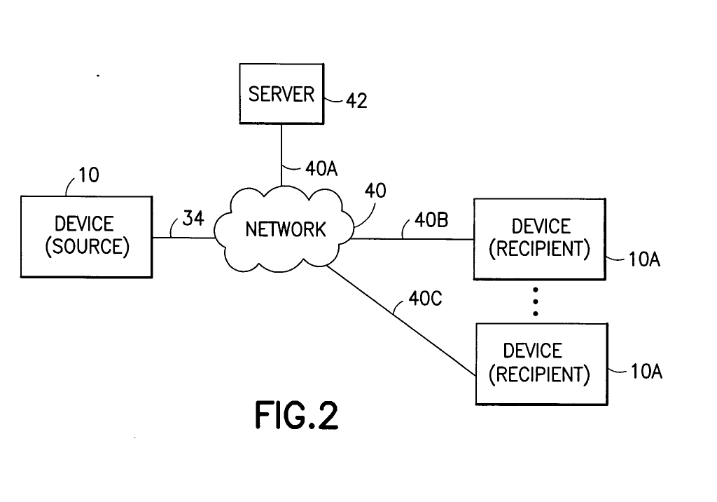

FIG. 2 depicts the device 10 connected to a network 40 via the link 34 (a wireless or wired link). The network 40 provides connectivity to one or more other devices 10A (which may or may not be constructed as the device 10 shown in FIG. 1). A server 42 may also be connected to the network 40, where the server may buffer information passing from the device 10 (which may be considered as a source device) to one or more of the devices 10A (which may be considered to be recipient device).

The network 40 may represent, as non-limiting examples, a wireless network (e.g., a cellular network), a local area network (LAN), a wireless local area network (WLAN), or the Internet. The network 40 may also represent plural network types that are interconnected together. For example, the source device 10 may be connected through a first cellular network, one of the recipient devices 10A may be connected via a wired Internet interface (e.g., a cable modem), another recipient device 10A may be connected via a WLAN, and yet another recipient device 10 may be connected via a second cellular network that differs in location and possibly access technology type from the first cellular network. In other words, the specifics of the connectivity between the source device 10 and the recipient devices 10A is not germane to an understanding (or the implementation) of this invention, and the network 40 is assumed to include whatever interworking mechanisms are needed to permit communication to occur between the source device 10 and one or more of the recipient devices 10A.

The exemplary embodiments of this invention provide the enhanced Calendar application 14B that allows sharing user-selected calendar-related time-blocks. The user may a select one or more start and end times/date(s) for sharing, which calendar(s) to share, and with whom. The recipient devices 10A receive calendar-related entries which may be locally stored as a (new) calendar.

It can be noted that the users of recipient device(s) 10A may optionally chose to acknowledge their action(s) to the source device 10 in response to receipt of a time-block from the source device 10. These actions may include: view the received time-block (or newly created calendar), save the received time-block, or ignore/delete the received time-block, as non-limiting examples.

The enhanced Calendar application 14B may enable sharing either continuous or discrete time ranges. A continuous time range implies sharing all entries starting from, for example, Monday, 15th September, 8:00 AM until Friday, 19th September 4:00 PM. A discrete time range implies, for example, sharing all entries taking place on, e.g., Mondays and/or Tuesdays between 8:00 AM and 4:00 PM during selected weeks (e.g., weeks 32 to 42).

As non-limiting examples, the ability to share specific Calendar entries may be useful for those Calendars related to work, e.g., to share with collaborators on a specific project. As another example, a group of people who are attempting to schedule a time for a meeting may selectively send their schedules, e.g., for the next week between 10:00 AM and 4:00 PM, to a common calendar that would then indicate a time or times during that week when everyone is available. As was noted above, those entries related to personal items (e.g., Doctor's appointments) may be excluded and not viewable by the recipient device users.

The ability to share specific Calendar time-blocks may also be useful for those Calendars related to personal items, e.g., to share with grandparents or other child care givers who participate in child care activities when a parent is at work.

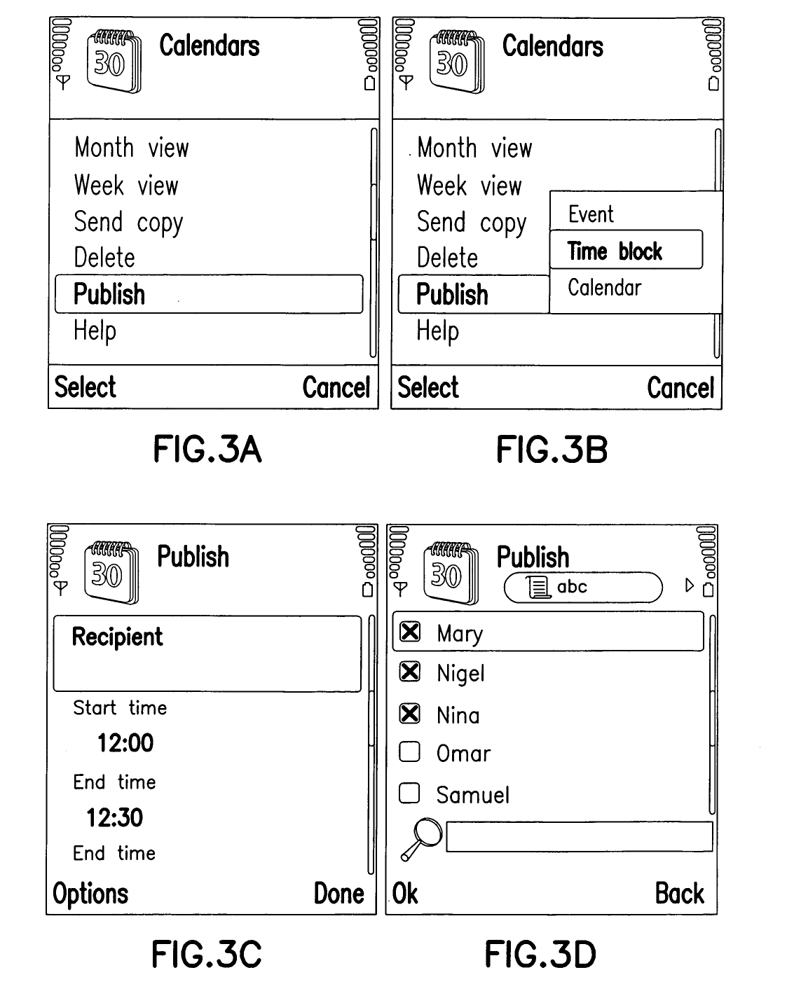

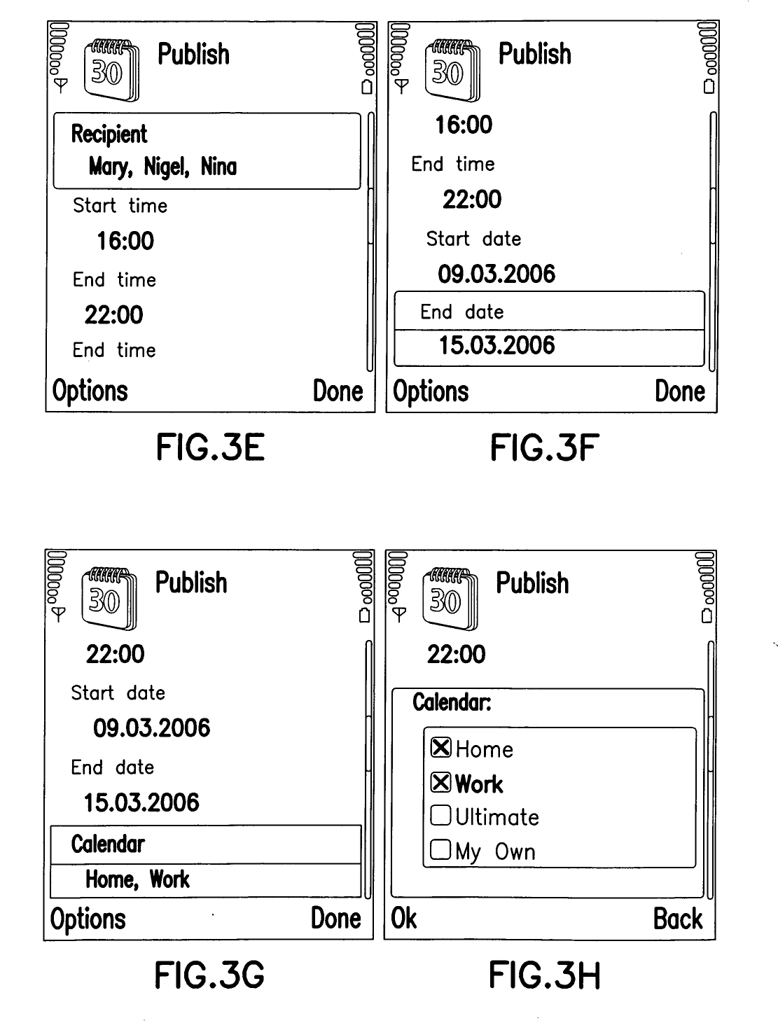

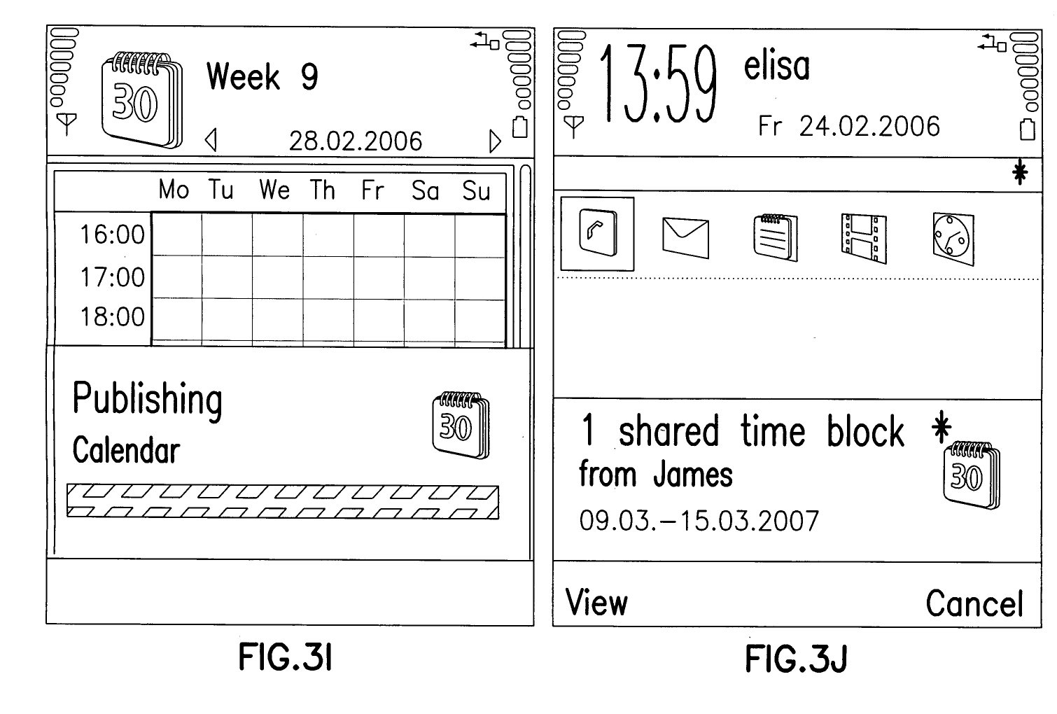

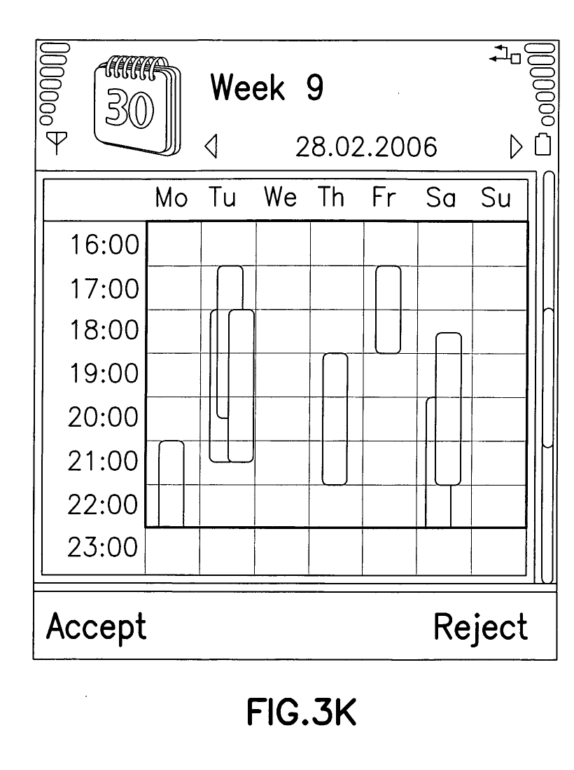

FIGS. 3A-3I show exemplary presentations on the display screen 16 during the use of the exemplary embodiments of this invention, and thus represent one possible user interface for sharing time-blocks. In this non-limited example the sharing of continuous time-blocks is shown.

In FIG. 3A the user interacts with the display screen 16 and user input (e.g., the keypad/keyboard 26) to select a Publish option in the Calendar application 14B. By selecting Publish option the user may be given the opportunity to select on of several Publish options, such as Event, Time-Block and Calendar. The user selects Time-Block in FIG. 3B. The user then selects the recipients of the shared time-block, e.g., using the information stored in the Contacts database 14C. This recipient selection is shown in FIGS. 3C and 3D, where the user has selected Mary, Nigel and Nina. Next the user selects the time range for sharing (FIGS. 3E and 3F), which in this case is 16:00 to 22:00 with a Start Date of Mar. 9, 2006 and an End Date of Mar. 15, 2006 (in these Figures the selected information is assumed to be scrolling upwards on the display screen 16). In FIGS. 3G and 3H the user selects which calendar or calendars are to be selected for sharing. In this example the user has selected the calendar entitled Work, it being assumed that there are multiple calendars available in the device 10 (although there need not be). FIG. 3I shows a final result of the Publish Time-block operation, where the selected Work calendar time-block (containing multiple calendar entries) is sent (published) to the identified recipients. This occurs by the Calendar application 14B extracting the information descriptive of the selected time-block from the Work calendar, and sending the extracted calendar entry (entries) via the transceiver 30 and the link 34 to the recipient devices 10 via the network 40. Note that any type of suitable signaling can be used for this purpose, including internet protocol (IP) messaging, SMS, MMS and email, as non-limiting examples.

Note as well that the order of selections may be different than that shown in FIGS. 3A-3I. For example, the Calendar(s) to be shared may be selected first, followed by the start/end times and the date(s) that define the time-block of interest, followed by the selection of recipient or recipients.

FIGS. 3J and 3K illustrate exemplary screen images that may appear on the display of a person receiving a shared time-block in accordance with the exemplary embodiments of this invention. In FIG. 3J the recipient is notified that he has received a shared time-block from James that covers the period of March 9 through Mar. 15, 2007. FIG. 3K shows the received time-block, which covers the times 16:00-22:00 during the specified date period. The recipient is also given the opportunity to acknowledge, and may Accept or Reject the received time-block for inclusion in his Calendar application database.

It is also within the scope of the exemplary embodiments of this invention for the user of the source device 10 to choose to share only free/busy data of selected entries/calendars. Further, the sharing may encompass one or more options such as: share all details, share only location, share only free/busy, as non-limiting examples.

Note also that the recipient of a shared time-block may choose to send the acknowledgement of their action to the sender of the time-block. This ability to send an acknowledgment is not shown in FIGS. 3A-3I.

It should be appreciated that the start/end time and date selection may be performed differently. For example, and instead of entering times and dates as in FIGS. 3E, 3F, while viewing the selected calendar (e.g., a week view or a month view) on the display screen 16 the user may employ the user input device to highlight a portion or portions of one or more displayed days in order to define the time-block for sharing with the recipient(s).

If desired, the user may be given the opportunity to review his or her selections prior to sending them (publishing them), and to make modifications (e.g., add/remove entries) if needed.

In an exemplary embodiment, when a time-block is constructed by the user all events fulfilling the selection criteria may be exported from the database of the Calendar application 14B (or from several databases if multiple calendars have separate storage areas). The selected events to be shared are then forwarded to a sharing engine (which may be embodied in the server 42 of FIG. 2) that in turn handles transferring the events to the selected recipient devices 10A. Note that this transfer may occur by the sharing engine 40 sending the events as one SIP (session initiation protocol) package to the selected recipient devices 10A. The recipient devices 10A may be notified of the incoming events and, if the transfer is accepted, the events that comprise the time-block are imported to the recipient's calendar database. This may include the Calendar application 14B creating a new calendar in the recipient device 10A that contains, at least initially, only the received entries. As a part of being notified of an incoming time-block the user of the recipient device 10A may be given an opportunity to preview the received time-block before making a decision as to the disposition of the received time-block (e.g., accept the received time-block or reject the received time-block). Also, and as was noted above, an acknowledgment of receipt of the received time-block may be transmitted back towards the source device 10.

The exemplary embodiments of this invention provide in one aspect thereof a method, apparatus and computer program to share a time-block comprised of electronic calendar entries.

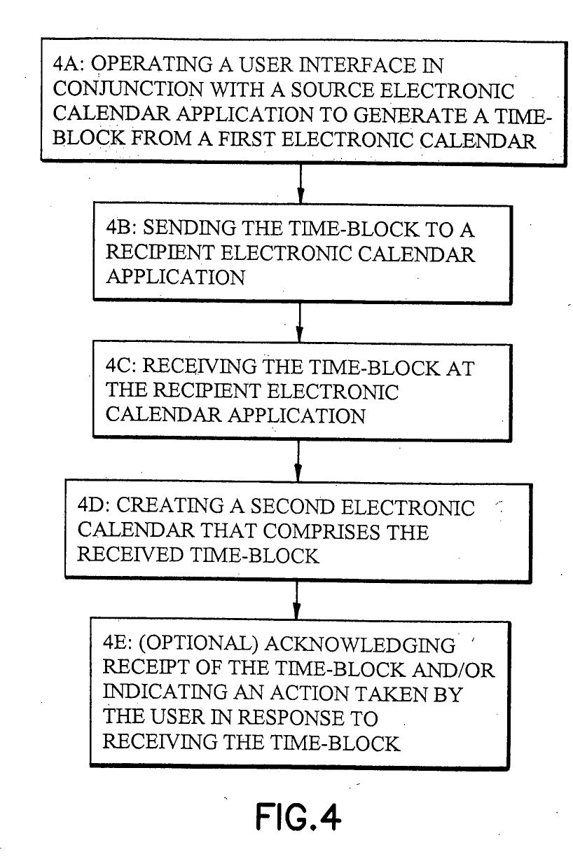

Referring to FIG. 4, in accordance with a method and the execution of computer program instructions stored in a computer-readable memory medium, at Block 4A there is performed a step of operating a user interface in conjunction with a source electronic calendar application to generate a time-block from at least one first electronic calendar; and at Block 4B a step of sending the time-block to a recipient electronic calendar application. At Block 4C there is a step of receiving the time-block at the recipient electronic calendar application; and at Block 4D creating a second electronic calendar that comprises the received time-block. Block 4E shows an optional step of acknowledging receipt of the time-block and/or indicating an action taken by the user in response to receiving the time-block.

The step of operating the user interface comprises a user selecting at least one date and a start time and an end time for the at least one date to generate the time-block, where the time-block comprises a plurality of first electronic calendar entries descriptive of a plurality of scheduled events.

The step of operating the user interface further comprises selecting at least one recipient, generating the at least one time-block comprises selecting a date range comprised of one or more calendar dates, a start time and an end time. Selecting the at least one recipient may use a contacts database. The step of operating the user interface may further include selecting one of a plurality of first electronic calendars from which to generate the time-block.

The various blocks shown in FIG. 4 may be viewed as method steps, and/or as operations that result from operation of computer program code, and/or as a plurality of coupled logic circuit elements constructed to carry out the associated function(s). In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims. As but some examples, the use of other different, similar or equivalent techniques for interacting with the user to define time-blocks and to publish time-blocks may be attempted by those skilled in the art.

As a further example, in another exemplary use case the time-blocks may be used in a non-intrusive manner to define availability of one or more persons with regard to one or more events. Assume that a certain user is interested in identifying a time within a certain time-block as to when the user could have a meeting with colleagues. The user defines the time-block on the user's personal calendar (e.g., Monday-Wednesday, between 9AM and 1PM). However, instead of sending this particular time-block to the colleagues the user selects an option in the time-block related menu whereby an enquiry is made as to times when all members in a particular set of users (the set of colleagues in this case) have the ability to meet within the particular time-block defined by the user. Any of the matches identified may then be sent to the persons in this particular set in the form of a meeting invitation. Note that the enquiry may be made to an external agency, such as to one embodied in the server 42 in FIG. 2, which in this case is assumed to have knowledge, or is assumed to be capable of gaining knowledge, of the electronic calendar information of the various other persons of interest. The external agency in this case may also be responsible for analyzing the calendar information, for selecting a particular meeting time that is compatible with all involved persons, for sending the invitations and possibly also for managing the responses to the invitations. The external agency in this case may also be considered to correspond to at least one recipient electronic calendar application.

All such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
operating a user interface in conjunction with a source electronic calendar application to generate a time-block from at least one first electronic calendar; and
sending the time-block to a recipient electronic calendar application.

2. The method of claim 1, further comprising:
receiving the time-block at the recipient electronic calendar application;
creating a second electronic calendar that comprises the received time-block; and
optionally acknowledging receipt of the time-block.

3. The method of claim 1, where operating the user interface comprises a user selecting at least one date and a start time and an end time for the at least one date.

4. The method of claim 1, where the time-block comprises a plurality of first electronic calendar entries descriptive of a plurality of scheduled events.

5. The method of claim 1, where operating the user interface further comprises:
selecting at least one recipient;
and where generating the at least one time-block comprises selecting a date range comprised of one or more calendar dates, a start time and an end time.

6. The method of claim 5, where selecting at least one recipient uses a contacts database.

7. The method of claim 5, further comprising selecting one of a plurality of first electronic calendars from which to generate the time-block.

8. A computer-readable memory medium that stores program instructions the execution of which results in operations that comprise:
operating a user interface in conjunction with a source electronic calendar application to generate a time-block from at least one first electronic calendar; and
sending the time-block to a recipient electronic calendar application.

9. The computer-readable memory medium of claim 8, further comprising operations performed at a recipient device of:
receiving the time-block at the recipient electronic calendar application;
creating a second electronic calendar that comprises the received time-block; and
optionally acknowledging receipt of the time-block.

10. The computer-readable memory medium of claim 8, where operating the user interface comprises a user selecting at least one date and a start time and an end time for the at least one date.

11. The computer-readable memory medium of claim 8, where the time-block comprises a plurality of first electronic calendar entries descriptive of a plurality of scheduled events.

12. The computer-readable memory medium of claim 8, where operating the user interface further comprises:
selecting at least one recipient;
and where generating the at least one time-block comprises selecting a date range comprised of one or more calendar dates, a start time and an end time.

13. The computer-readable memory medium of claim 12, where selecting at least one recipient uses a contacts database.

14. The computer-readable memory medium of claim 12, further comprising selecting one of a plurality of first electronic calendars from which to generate the time-block.

15. An apparatus, comprising:
a data processor;
a memory that stores an electronic calendar application and an associated electronic calendar database that stores data representing at least one electronic calendar;
a user interface; and
a transmitter;
said data processor configurable to operate with said electronic calendar application and to receive user input from said user interface to generate a time-block from said at least one electronic calendar and to send the time-block through said transmitter to a recipient electronic calendar application in another apparatus.

16. The apparatus of claim 15, further comprising a receiver configurable to receive a time-block from another electronic calendar application residing in another apparatus, said data processor further configurable to create a new electronic calendar that comprises the received time-block and to optionally acknowledge receipt of the time-block.

17. The apparatus of claim 15, where a user enters at least one date and a start time and an end time for the at least one date into said user interface for use in generating the time-block.

18. The apparatus of claim 15, where the time-block comprises a plurality of electronic calendar entries descriptive of a plurality of scheduled events.

19. The apparatus of claim 15, where a user enters information into the user interface to select at least one recipient of the time-block; and to select a date range comprised of one or more calendar dates, a start time and an end time to define the time-block.

20. The apparatus of claim 19, where the at least one recipient is selected from a contacts database that is displayed to the user via the user interface.

21. The apparatus of claim 19, where a user enters information into the user interface to select one of a plurality of electronic calendars stored in the electronic calendar database from which to generate the time-block.

22. The apparatus of claim 15, where the transmitter is comprised of a transmitter adapted to be coupled to a wireless communication link, or a transmitter adapted to be coupled to a wired communication link.

23. An apparatus, comprising:
means for interfacing to a communication network;
means for presenting information to a user and for receiving information from the user;
means for storing an electronic calendar application and at least one electronic calendar;
means responsive to information received from the user for generating a time-block from the at least one electronic calendar for sending the time-block to a recipient electronic calendar application through said interfacing means, information received from the user comprising at least one date and a start time and an end time for the at least one date and the time-block comprising a plurality of electronic calendar entries descriptive of a plurality of scheduled events and defined by the at least one date and the start time and the end time for the at least one date;
means responsive to a time-block received through said interfacing means for creating in said storing means a new electronic calendar containing entries that comprise those in received time-block; and
means for optionally acknowledging receipt of the time-block and for indicating an action taken by the user in response to receiving the time-block.

24. The apparatus of claim 23, where said generating means is also responsive to information received from the user for selecting at least one recipient for the time-block.

25. The apparatus of claim 23, where said generating means is also responsive to information received from the user for selecting one of a plurality of electronic calendars from said storing means.
